(19) United States
(12) Patent Application Publication
(10) Pub. No.: US 2010/0226831 A1
(43) Pub. Date: Sep. 9, 2010

(54) Plasma generating nozzle based on magnetron

(76) Inventor: Sang Hun Lee, San Ramon, CA (US)

Correspondence Address: JORDAN AND HAMBURG LLP, 122 EAST 42ND STREET, SUITE 4000, NEW YORK, NY, 10168, US

(21) Appl. No.: 12/380,835

(22) Filed: Mar. 4, 2009

(51) Int. Cl. H05H 1/04

(52) U.S. Cl. 422/186.03

(57) ABSTRACT

The present invention provides a plasma generating system including a magnetron for generating microwave energy, a resonator attached to the magnetron and having a cavity to contain the microwave energy generated by the magnetron, and at least one nozzle secured to the resonator. The nozzle includes a housing having a generally cylindrical space formed therein, wherein the space forms a gas flow passageway; and a rod-shaped conductor disposed in the space and operative to transmit microwave energy along a surface thereof so that the microwave energy transmitting along the surface excites gas flowing through the space. A portion of the rod-shaped conductor extends into the cavity to capture the microwave energy in the cavity. The nozzle includes gas inlet structure configured to introduce gas into the cylindrical space to be excited into plasma

### BACKGROUND OF THE INVENTION

1. Field of the Invention

The present invention relates to plasma generators, and more particularly to devices having a nozzle based on a magnetron.

2. Discussion of the Related Art

In recent years, the progress on producing plasma by use of microwave energy has been increasing. Typically, a plasma producing system includes a device for generating microwave energy, a nozzle that receives the microwave energy to excite gas flowing through the nozzle into plasma, and a wave transfer mechanism, such as microwave waveguide, to transfer the microwave energy from the device to the nozzle. In certain applications, it is advantageous to eliminate the wave transfer mechanism so that the form factor of the entire system can be reduced. In such a system, the energy loss in the conventional wave transfer mechanism can be obviated to thereby enhance the operational efficiency of the system and reduce the cost for manufacturing the system. As such, there is a need for a plasma generating system that does not include a conventional wave transfer mechanism.

### SUMMARY OF THE INVENTION

Briefly state, an embodiment of the present invention provides a plasma generating system which includes: a magnetron for generating microwave energy; a resonator attached to the magnetron and having a cavity to contain the microwave energy generated by the magnetron; and at least one nozzle secured to the resonator. The nozzle includes: a housing having a generally cylindrical space formed therein, where the space forms a gas flow passageway; and a rod-shaped conductor disposed in the space and operative to transmit microwave energy along a surface thereof so that the microwave energy transmitting along the surface excites gas flowing through the space. A portion of the rod-shaped conductor extends into the cavity to capture the microwave energy in the cavity. A gas inlet structure is further provided to feed gas into the gas flow passageway to be excited into plasma

An optional arrangement of the present invention provides the gas inlet structure a gas inlet hole defined by the housing and communicated to the gas flow passageway.

A feature of the present invention includes an electrical insulator disposed in the space and adapted to hold the rod-shaped conductor relative to the housing.

Yet another optionally provided feature of the present invention includes the electrical insulator defining the gas inlet structure as at least one through hole angled with respect to a longitudinal axis of the rod-shaped conductor to impart a helical shaped flow direction around the rod-shaped conductor to a gas passing through the through hole.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” LANGUAGE are not to be considered limited to equivalents of specific embodiments described herein.

### BRIEF DESCRIPTION OF THE DRAWINGS

The present invention is describe below with reference to the following drawings wherein likeitems are identified with like reference designators and are shown for exemplary purposes, wherein:

FIG. 1 shows an exploded view of a plasma generating system in accordance with one embodiment of the present invention.

FIG. 2 shows a side cross-sectional view of a portion of the plasma generating system of FIG. 1, taken along the line II-II.

FIG. 3 shows a side cross-sectional view of a plasma generating system in accordance with another embodiment of the present invention.

### DETAILED DESCRIPTION OF THE PREFERRED EMBODIMENTS

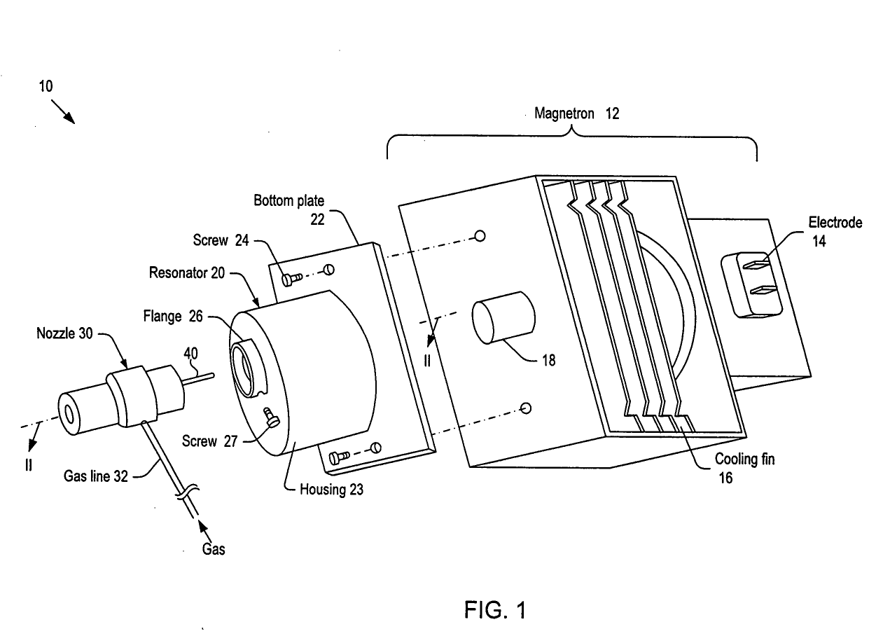

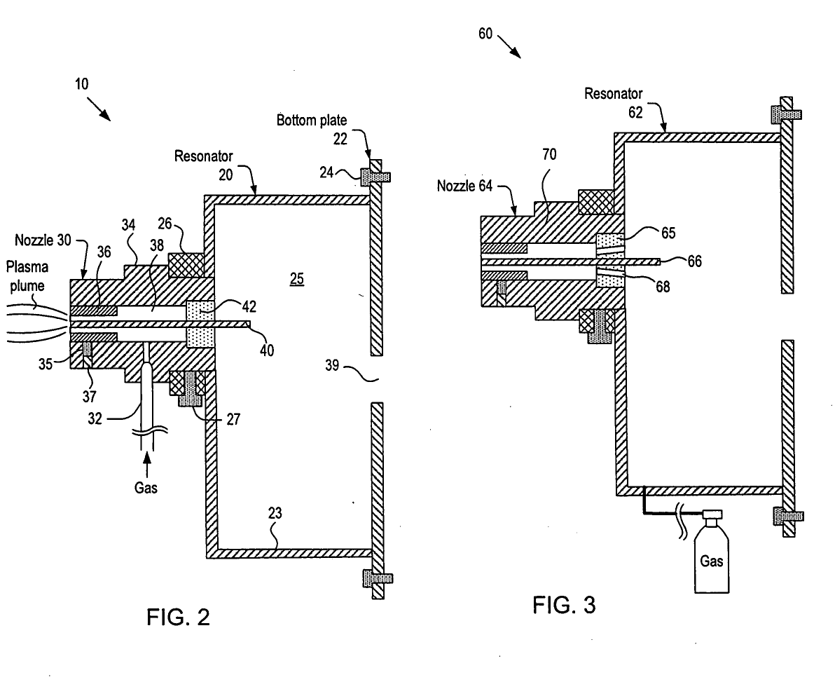

FIG. 1 shows a schematic diagram of a plasma generating system 10 in accordance with one embodiment of the present invention. FIG. 2 shows a side cross-sectional view of a portion of the plasma generating system 10, taken along the line II-II. For brevity, the magnetron 12 is not shown in FIG. 2. As depicted, the system 10 includes: a magnetron 12 for generating microwave energy; a resonator 20; and a nozzle 30 secured to the resonator 20. The magnetron 12 may have a structure similar to a conventional magnetron. For instance, the magnetron 12 has electrodes 14 for receiving electrical power from a power supply (not shown in FIG. 1), cooling fins (or heat sink) 16 for removing heat energy generated during operation from the magnetron; and an antenna 18 for transmitting microwave energy therefrom. A fan (not shown in FIG. 1) may be used to blow airflow through the cooling fins 16 during operation such that the heat energy is extracted from the cooling fins 16.

The resonator 20 operates as a container for containing microwave energy transmitted by the antenna 18. The resonator 20 includes a bottom plate 22 sealingly secured to the magnetron 12 by one or more suitable fasteners 24, such as screws, and having an opening 39 through which the antenna 18 extends; and a housing 23 that forms a resonator cavity 25 thereinside. A ring-shaped flange 26 is affixed to the top surface of the resonator 26. In FIGS. 1 and 2, the ring-shaped flange 26, the resonator housing 23, and the bottom plate 22 are shown as separate components. However, it should be apparent to those of ordinary skill in the art that two or more of the housing 23, the bottom plate 22, and the ring-shaped flange 26 may be formed as an integral body.

A nozzle 30 is detachably secured to the flange 26 by one or more suitable fasteners 27, such as screws. The nozzle 30 includes a rod-shaped conductor 40; a housing or shield 34 formed of conducting material, such as metal, and having a generally cylindrical cavity/space 38 therein so that the space 38 forms a gas flow passageway; an electrical insulator 42 disposed in the space 38 and adapted to hold the rod-shaped conductor 40 relative to the shield 34; a dielectric tube 36 disposed in the space 38; a spacer 35; and a fastener 37, such as a metal screw, for pushing the spacer 35 against the dielectric tube 36 to thereby secure the dielectric tube 36 to the shield 34. The spacer 35 is formed of dielectric material, such as Teflon®), and functions as a buffer so that the fastener 37 can firmly push the dielectric tube 36 against the shield 34 without cracking the dielectric tube 36.

A top portion of the rod-shaped conductor 40 protrudes into the resonator cavity 25 and operates as an antenna to capture a portion of the microwave energy in the resonator cavity 25. The captured microwave energy flows along the surface of the rod-shaped conductor 40. The gas supplied via a gas line 32 is injected into the space 38 of the nozzle 30 and excited by the microwave energy flowing along the surface of the rod-shaped conductor 40. The gas exiting the nozzle 30 may be neutral or in the form of plasma. The rod-shaped conductor 40, the dielectric tube 36, and the electric insulator 42 have functions similar to those of their counterparts of a nozzle described in U.S. Pat. No. 7,164,095, which is herein incorporated by reference in its entirety. For brevity, these components are not described in detail in the present document.

It is noted that the resonator housing 23 may have another geometrical shape, such as a shape of a rectangular cylinder. In such a case, the nozzle 30 may be attached to a sidewall of the resonator housing.

It is noted that the system 10 does not have any wave transfer mechanism, such as waveguide. As such, the system 10 is suitable for applications that require a small form factor. Also, the energy loss in the conventional wave transfer mechanism can be reduced, yielding an enhanced operational efficiency.

FIG. 3 shows a side cross-section view of a plasma generating system 60 in accordance with another embodiment of the present invention. As depicted, the system 60 is similar to the system 10 of FIG. 1 except for as discussed herein hence discussion of unlabeled parts is omitted as they are discussed in relation to the embodiment of FIG. 1. The system 60 of FIG. 3 differs from the system 10 of FIG. 2 in the gas injection system. As depicted, the gas is supplied through a resonator 62 and through holes 68 formed in an electric insulator 65, i.e., a housing/shield 70 of the nozzle 64 does not have any gas injection hole. The through holes 68 may be angled relative to the longitudinal axis of a rod-shaped conductor 66 to impart a helical shaped flow direction around the rod-shaped conductor to a gas passing along the through holes.

It is also noted that the plasma generating systems depicted in FIGS. 1-2 have only one nozzle. However, it should be apparent to those of ordinary skill that more than one nozzle can be used in each system. Detailed descriptions of systems having multiple nozzles and methods for operating the systems can be found in U.S. Pat. No. 7,164,095 and U.S. Patent Publication Serial Nos. 2006/0021581, 2006/0021980, 2008/0017616 and 2008/0073202, which are herein incorporated by reference in their entirety.

As discussed above, a nozzle, such as 30 or 64, may be attached to a sidewall of a resonator housing having a shape of a rectangular cylinder. In such a case, the nozzle may have a mechanism to move the rod-shaped conductor relative to the nozzle housing. More detailed information of the mechanism to move the rod-shaped conductor can be found in a copending U.S. patent application Ser. No. 12/315,913 entitled “Plasma generating system having tunable plasma nozzle,” filed on Dec. 8, 2008, which is herein incorporated by reference in its entirety. For brevity, the nozzle having a mechanism to move the rod-shaped conductor similar to the mechanism described in the copending U.S. patent application Ser. No. 12/315,913 is not shown in the present document.

The nozzle, such as 30 or 64, may have a mechanism to bias the electrical potential between the rod-shaped conductor and the nozzle housing. More detailed information of the mechanism to bias the electrical potential can be found in a copending U.S. patent application Ser. No. 12/322,909, entitled “PLASMA GENERATING SYSTEM HAVING NOZZLE WITH ELECTRICAL BIASING,” filed on, Feb. 9, 2009, of which the present inventor is also the inventor and which is herein incorporated by reference in its entirety. For brevity, the nozzle having a mechanism to bias the electrical potential described in the copending U.S. patent application entitled “PLASMA GENERATING SYSTEM HAVING NOZZLE WITH ELECTRICAL BIASING” is not shown in the present document.

Having described preferred embodiments of the invention with reference to the accompanying drawings, it is to be understood that the invention is not limited to those precise embodiments, and that various changes and modifications may be effected therein by one skilled in the art without departing from the scope or spirit of the inventions defined in the appended claims. Such modifications include substitution of components for components specifically identified herein, wherein the substitute component provides functional results which permit the overall functional operation of the present invention to be maintained. Such substitutions are intended to encompass as replacements for components and components yet to be developed which are accepted as replacements for components identified herein and which produce results compatible with operation of the present invention. Furthermore, the signals used in this invention are considered to encompass any electromagnetic wave transmission.

What is claimed is:

1. A plasma generating system, comprising:
a magnetron for generating microwave energy;
a resonator attached to the magnetron and having a cavity to contain the microwave energy generated by the magnetron; and
at least one nozzle assembly secured to the resonator and including:
a housing having a generally cylindrical space formed therein, the space forming a gas flow passageway;
a rod-shaped conductor disposed in the space and operative to transmit microwave energy along a surface thereof so that the microwave energy transmitting along the surface excites gas flowing through the space, wherein a portion of the rod-shaped conductor extends into the cavity; and
a gas inlet structure configured to introduce gas into said cylindrical space to be excited into plasma.

2. A plasma generating system as recited in claim 1, wherein the gas inlet structure includes the housing defining a gas inlet hole communicated to said space.

3. A plasma generating system as recited in claim 1, further comprising an electrical insulator disposed in the space and adapted to hold the rod-shaped conductor relative to the housing.

4. A plasma generating system as recited in claim 3, wherein the electrical insulator includes the gas inlet structure configured as at least one through hole angled with respect to a longitudinal axis of the rod-shaped conductor to impart a helical shaped flow direction around the rod-shaped conductor to a gas passing through the through hole.

5. A plasma generating system as recited in claim 1, wherein the magnetron includes an antenna extending into the cavity.
